(19) United States
(12) Patent Application Publication
(10) Pub. No.: US 2009/0123060 A1
(43) Pub. Date: May 14, 2009

(54) INSPECTION SYSTEM

(75) Inventors: Tong Liu, Singapore (SG); Zhong Ping Fang, Singapore (SG)

Correspondence Address: JACOBSON HOLMAN PLLC, 400 SEVENTH STREET N.W., SUITE 600, WASHINGTON, DC, 20004, US

(73) Assignee: AGENCY FOR SCIENCE, TECHNOLOGY AND RESEARCH, Singapore (SG)

(21) Appl. No.: 11/658,312

(22) PCT Filed: Jul. 29, 2004
(86) PCT No.: PCT/SG2004/000225

§ 371 Date: Dec. 22, 2008

(51) Int. Cl. G06K 9/00

(52) U.S. Cl. 382/149

(57) ABSTRACT

An inspection system (10) for three dimensional inspection of minute objects (11) on a substrate (12), the system comprising: a calibration module (20) to calibrate an inspection angle (30) for capturing an oblique image of the objects, the calibration of the inspection angle being performed by using one object as a reference; at least one image capturer (23) to capture a first image of the objects, and to capture an oblique image of the objects; and an image processor (24) to determine the position of the objects using the first image, and the height of the objects using the oblique image and the first image; wherein if the height of an object is not within a predetermined criteria it is classified as defective and the position of the defective object is identified.

### TECHNICAL FIELD

The invention concerns an inspection system for three dimensional inspection of minute objects on a substrate.

### BACKGROUND OF THE INVENTION

The inspection of packaging for electronic devices such as integrated chip (IC) packaging is widely used in the electronic industry. ICs, electronic chip or chip packages, such as ball grid array (BGA) types, are placed in a tray and passed through an inspection device. The purpose of the inspection is to measure the coplanarity (relative heights), colinearity (alignment) and the height of each solder ball on the BGA of an IC chip, or solder bumps on wafer and die. As is known in the prior art, these height measurements can be accomplished by laser triangulation methods, interferometry, and other non-contact measurements. However all tend to be either complex, difficult, inaccurate or slow to implement in a manufacturing setting.

BGAs on ICs typically use a group of solder dots, or balls, arranged in different patterns, to connect to a circuit board. However, if there is a missed connection, the IC is defective. Common causes for incomplete solder bonds include insufficient ball height and missing solder balls resulting from dislodgement during handling. Therefore it is important to maintain high standards of production quality by performing thorough inspections of BGAs.

Typically, inspection of a BGA is performed prior to assembly on a printed circuit board. If a defective BGA is detected, the IC can be rejected instead of rejecting an entire printed circuit board with the IC.

Conventional techniques such as interferometry, confocal and laser range finding have been widely used for inspecting solder balls in a BGA on an integrated circuit chip or similar structure. Based on precision optical design, these methods might achieve high measurement resolution but they suffer from low measurement speed. Shadow imaging is highly susceptible to inaccuracies and can lead to object irregularities proceeding undetected.

Referring to FIG. 1A, a prior art technique for inspecting heights of a minute object, for example, a BGA, is a triangulation method, in which a laser beam is precisely directed onto the top of a BGA ball, and a photo sensor or image sensor is used to detect the reflected lighting beam. By triangulation calculation, the ball height of the BDA can be inspected. This method suffers from low resolution, low accuracy and low inspection speed.

FIG. 1B shows another prior art technique, a stereo measurement system, which uses a two or three-camera system to view the object from different angle. By perspective vision, the measurement system may be able to inspect a large area at high speed, but because of image distortion, it requires precisely positing the devices and complicated calibration. In fact, it is only a comparator comparing devices with the calibrated master device. This method suffers from low inspection resolution.

Referring to FIG. 1C, another two-camera system uses one camera to view the BGA device in the normal direction is provided. The X and Y dimensions are determined and then each row of BGA is moved to a predetermined position and a second camera is used to view the top edges of the balls from an angle. This method is another variation of a stereo vision system. In order to eliminate the perspective error and magnification variation in different positions of the field of view, it inspects one row of balls at a time. Therefore, it suffers from low inspection speed.

Prior art devices and techniques are unable to precisely measure and verify the height of minute objects in an expeditious manner.

### SUMMARY OF THE INVENTION

In a first preferred aspect, there is provided an inspection system for three dimensional inspection of minute objects on a substrate, the system comprising:
a calibration module to calibrate an inspection angle for capturing an oblique image of the objects, the calibration of the inspection angle being performed by using one object as a reference;
at least one image capturer to capture a first image of the objects, and to capture an oblique image of the objects; and
an image processor to determine the position of the objects using the first image, and the height of the objects using the oblique image;
wherein if the height of an object is not within a predetermined criteria it is classified as defective and the position of the defective object is identified.

The system may further comprise a tilt measurement module to measure a tilting angle of the substrate. The tilting angle may be used when determining the position and height of the objects.

The inspection angle may be calibrated by observing the top-position variation of an object in two consequent images taken by the image capturer when the object is moved a given distance within the depth of view of the optics of the image capturer.

The system may further comprise an illumination source to illuminate the objects on the substrate. The illumination source may be a diffused linear light source. The illumination source may be Light Emitting Diodes (LEDs) arranged in an arc or in a line. The illumination source may strobe when capturing the image. The illumination source may strobe to capture a specific object in a moving state.

The system may comprise two image capturers. The image capturers may have telecentric lenses. Telecentric lenses ensure magnification uniformity of the images of all the objects even though the objective distances of the objects are different.

The telecentric lenses minimises size distortion.

The optical axis of a first image capturer may be perpendicular to the plane of the substrate.

The optical axis of a second image capturer may be at the inspection angle. The inspection angle is the angle between the optical axis of the tilted capturer and the plane of the substrate. Preferably, the inspection angle is small, about ten degrees. Advantageously, by having a small inspection angle, high accuracy is achieved and sensitivity to the shape of the objects is obtained.

The substrate may be a semiconductor chip, printed circuit board, semiconductor water, integrated circuit module or electronic device. The substrate may be placed in an industrial standard tray carried by a transportation mechanism. The transportation mechanism may be a conveyor system or an XY moving stage.

The objects may be solder balls or wafer bumps or golden bumps. The objects may be arranged as a ball grid array (BGA), solder bump array or wafer bumps.

The image capturer may be a high resolution digital imaging device. For example, a Charge Coupled Device (CCD) camera or CMOS camera.

In a second aspect, there is provided a method for three dimensional inspection of minute objects on a substrate, the method comprising:
calibrating an inspection angle for capturing an oblique image of the objects, the calibration of the inspection angle being performed by using one object as a reference;
capturing a first image perpendicular to the substrate of the object and the oblique image of the objects; and
determining the position of the objects using the first image, and the height of the objects using the oblique image and the first image;
wherein if the height of an object is not within a predetermined criteria it is classified as defective and the position of the defective object is identified.

The method may further comprise an initial step of calibrating the magnification of the image capturer.

The method may further comprise the step of determining the tilting angles of the substrate. The height of the objects may be revised with the tilting angles.

The height of the objects may be calculated by comparing the objects to the height of the object used as the reference.

The absolute height of each object may be determined by using the absolute height of the object as a reference. The absolute height may be determined by other precision measurement methods, such as auto-focus, a laser range finder, confocal, or Interferometry.

Alternatively, the absolute height of each object may be determined by the combination of its normal value and the measured height variation if the average ball height is very close to the designed normal value.

The shape or curvature of the head of the objects may be determined using the oblique image.

All the objects on the substrate may be captured in each images.

The oblique image may be a bright arc image of each object's head. Advantageously, dark field illumination illuminates the object but does not admit light directly to the camera lens.

The system may also measure the co-linearity and co-planarity of the objects.

In a third aspect, the invention is an inspection system for three dimensional inspection of minute objects on a substrate, the system comprising:
a tilt measurement module to measure a tilting angle of the substrate,
at least one image capturer to capture a first image of the objects, and to capture an oblique image of the objects; and
an image processor to determine the position of the objects using the first image, the height of the objects using the oblique image and the first image, and compensation for the tilting angle;
wherein if the height of an object is not within a predetermined criteria it is classified as detective and the position of the defective object is identified.

The system may further comprise a calibration module to calibrate an inspection angle for capturing an oblique image of the objects, the calibration of the inspection angle being performed by using one object as a reference.

In a fourth aspect, there is provided a method for three dimensional inspection of minute objects on a substrate, the method comprising:
measuring a tilting angle of the substrate;
capturing a first image perpendicular to the substrate of the object, and an oblique image of the objects; and
determining the position of the objects using the first image, the height of the objects using the oblique image and the first image, and compensation for the tilting angle;
wherein if the height of an object is not within a predetermined criteria it is classified as defective and the position of the defective object is identified.

Advantageously, the present invention enables multiple objects are measured at the same time to achieve high speed and precise inspection of objects

### BRIEF DESCRIPTION OF THE DRAWINGS

An example of the invention will now be described with reference to the accompanying drawings, in which:

FIGS. 1A, 1B and 1C are a set of schematic drawings of prior art methods and devices;

FIG. 2 is a schematic drawing of a preferred embodiment of the system;

FIG. 3 is a two dimensional image and a three dimensional image captured by the system;

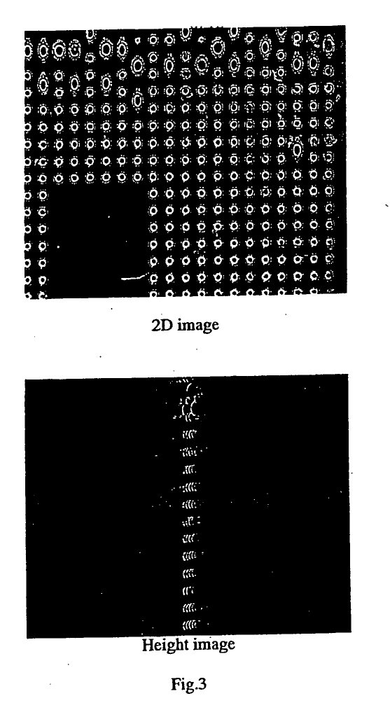

FIGS. 4A and 4B are illustrations of the trigonometric relationship between the height of an image and the height of an object;

FIG. 5 is an illustration of a two dimensional image of an object and a height image of the same object;

FIG. 6 is an illustration of an algorithm used for automatic determination of the tilting angles of a wafer;

FIG. 7 is an illustration of an algorithm used for automatic determination of the inspection angle of the tilted camera;

FIG. 8 is an example of a back lighting source for height image;

FIG. 9 is a schematic drawing of a second embodiment of the system;

FIG. 10 is a schematic drawing of a third embodiment of the system;

FIG. 11 is a schematic drawing of a fourth embodiment of the system; and

FIG. 12 is a process flow diagram for three dimensional inspection of minute objects on a substrate according to a preferred embodiment of the system.

### DETAILED DESCRIPTION OF THE DRAWINGS

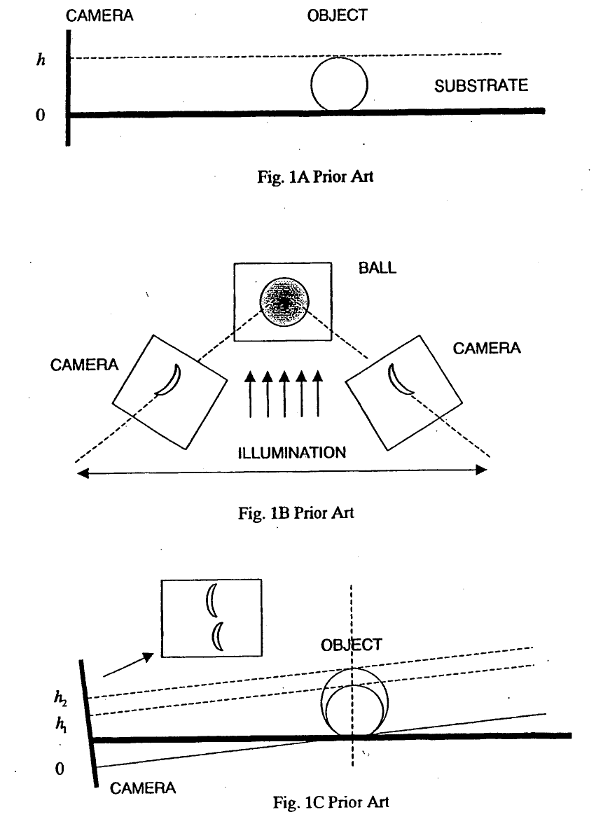

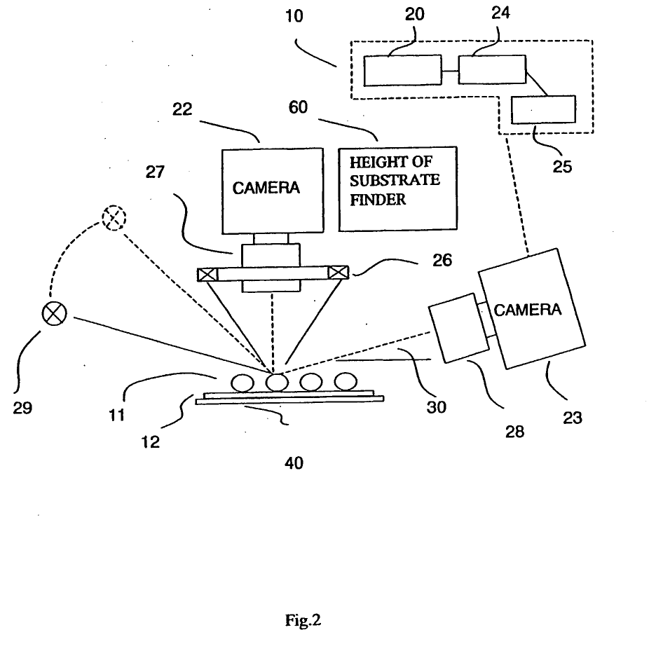

Referring to FIG. 2, there is provided an inspection system 10 for three dimensional inspection of minute objects 11 on a substrate 12. Minute objects 11 include, but are not limited to, solder balls 11, wafer bumps or Ball Grid Array (BGA) 12. The substrate 12 is placed in an industrial standard tray (not shown) carried by a transportation mechanism such as a conveyor belt 40. FIG. 1 depicts the system 10 as it might appear as part of a typical manufacturing process. The system 10 is part of a chip manufacturing facility (not shown), specifically, the quality control and inspection part of the operation.

The system 10 comprises a calibration module 20, two high resolution digital cameras (CCD) 22, 23 and an image processor 24. The calibration module 20 calibrates an inspection angle 30 by capturing two oblique images of the balls 11 at two different positions. Preferably, the inspection angle 30 is about 10° elevated from the plane of the substrate 12. The inspection angle 30 can be increased or reduced depending on the type of inspection required.

Preferably, telecentric lenses 27, 28 are provided in both CCD cameras 22, 23. However, telecentric lenses 28 may be provided for at least the oblique imaging CCD camera 23. Telecentric lenses eliminate dimensional distortion. Also, telecentric lenses provide uniformed optical magnification over the entire field of view of the camera. One of the cameras 22 captures a first image of the balls 11 from above (normal to the plane of the substrate). The other camera 23 captures an oblique image of the balls 11 at the inspection angle 30. Without telecentric lenses, only one row of balls 11 on the substrate 12 is able to be accurately measured. Using telecentric lenses allows multiple rows of balls 11 on the substrate 12 to be precisely imaged and captured by the camera 23 in a single image. The image processor 24 calculates the position of the balls 11 using the first image and calculates the height of the balls 11 using the oblique image and the first image. Calibration of the inspection angle 30 is performed by selecting a ball 11 on the substrate 12 as a reference object. This approach enables calibration to be performed quickly and precisely as only a single ball 11 is used as the reference object for comparison with all the other balls 11 on the substrate 12. Calibration only needs to be performed once for the measurement of balls 11 on a large wafer prior to inspection commencing.

The system 10 comprises a tilt measurement module 25 for measuring the tilting angle of the substrate 12. This increases the measurement accuracy of the ball 11 as the substrate may be tilted at a small angle for a variety of reasons. The module 25 provides automatic compensation for the tilting error of the system 10 and enables the system 10 to be insensitive to vibration.

The system 10 also comprises an arrangement of light emitting diodes (LEDs) 26 in a ring for illuminating the balls 11 on the substrate 12. The LEDs 26 are able to strobe the balls 11 or a specific ball 11 when capturing images. A secondary light source 29 comprises a line or area array of light emitting diodes 29 in an arc or other arrangement to illuminate the balls 11 from the side is also provided to produce a bright arc of the head of the balls 11. The bright arc images can be used to determine the shape of the balls 11. The secondary light source 29 can also strobe for high speed image capturing during scanning movement.

From the captured images, height differences of the balls 11 are determined by using of trigonometrical relationships in a height determination algorithm. This allows the coplanarity of the balls 11 on the BGA 12 to be measured.

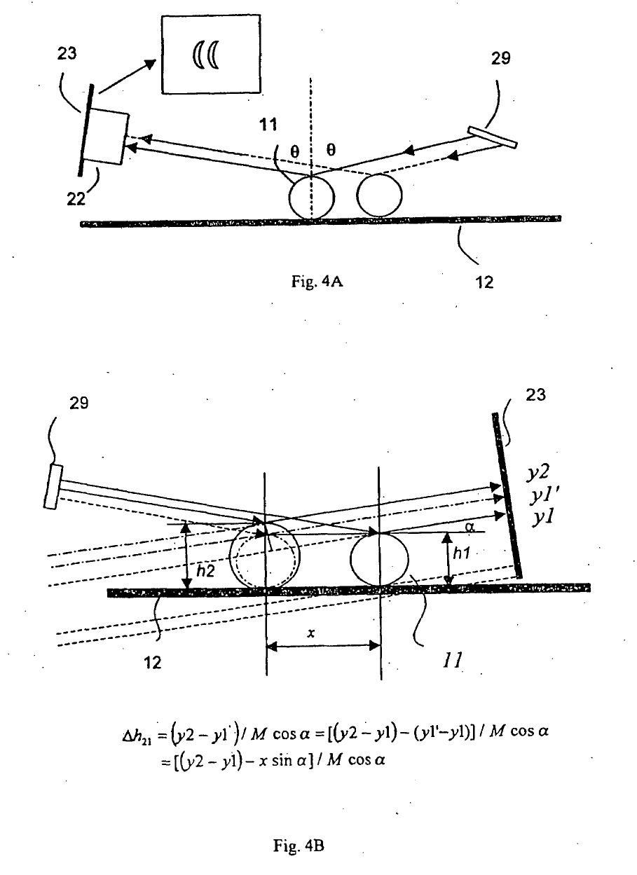

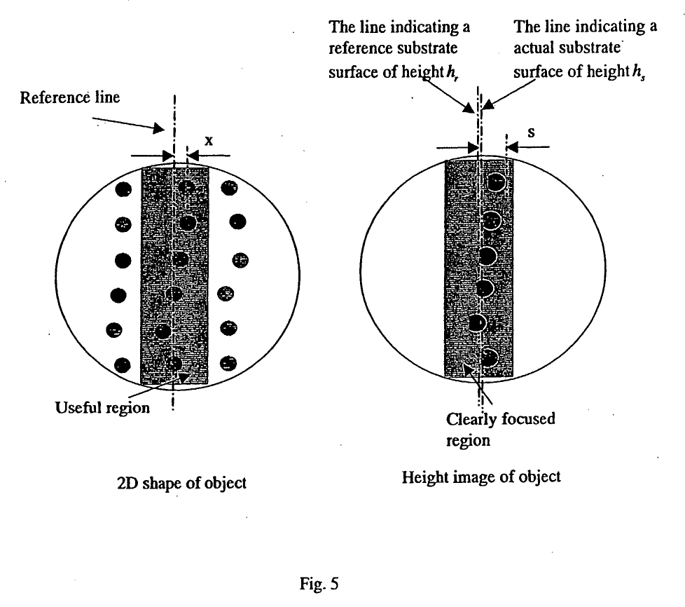

FIGS. 4A, 4B and 5 illustrate the trigonometric formula for determining the height of the balls 11. In FIG. 4A, a diffused arc line or area light source illuminates the top of the miniature objects 11. The telecentric lens is set up at the position to collect the reflected light from the top surfaces of the balls, but the illumination lighting cannot directly enter the telecentric lens. It is a dark field illumination system. The three parties: the light source, BGA and camera, are positioned in a triangulation and the triangulation relationship and images are used for calculating of the 3D ball height. The use of diffused line or area light source enables the top positions of the objects and their profiles to be identified in the crescent shape figures in only one image. Telecentric lens 22 provides uniform optical magnification over the entire field of view although some crescent shape figures at top and bottom of the image are defocused. The system can achieve high resolution and speed measurement. The trigonometric formula is:

$${h}_{1} = ( {y}_{1} - {h}_{0} ) / M cos α$$

$$\begin{matrix}Δ {h}_{21} = ( {y}_{2} - {y}_{1}^{′} ) / M cos α \\ = [ ( {y}_{2} - {y}_{1} ) - ( {y}_{1}^{′} - {y}_{1} ) ] / M cos α \\ = [ ( {y}_{2} - {y}_{1} ) - x sin α ] / M cos α\end{matrix}$$

and a common expression for the height of a ball on the substrate is given as:

hᵢ=[yᵢ−y₁−xᵢ sin α]/M cos α+hᵢ

where xᵢ=0.
and:
xᵢ is the distance between the i^{th} ball and the ball 1;
yᵢ is the image height of the apex of the i^{th} ball;
hᵢ is the height of the i^{th} ball;
M is the magnification of the lens of the camera 23; and
α is the inspection angle (angle between the camera 23 and the plane of the X, Y stage).

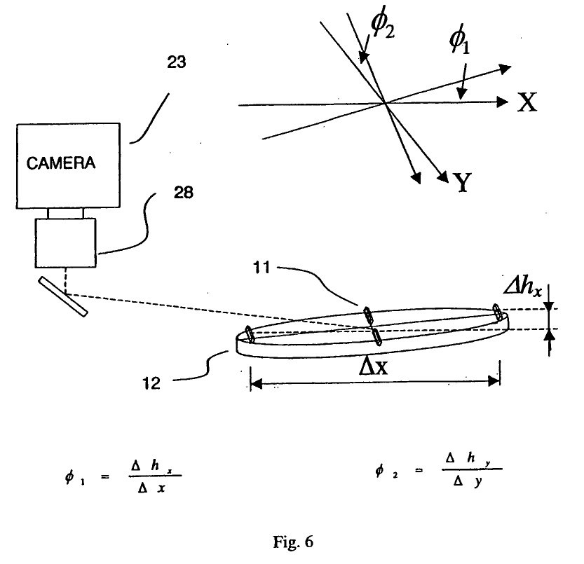

FIG. 6 illustrates the formula for determining the tilting angle of an unwarped wafer under measurement The same principle can be applied to each die/substrate for a warped wafer. For measuring the titling angles of a whole wafer, the average height of balls in one image is calculated at four end positions by moving the X, Y stage a predefined distance, which are obtained by the top view camera. The trigonometric formula is:

$${φ}_{x} = \frac{Δ {h}_{x}}{Δ x}$$

$${φ}_{y} = \frac{Δ {h}_{y}}{Δ y}$$

where:
φₓ is the tilting angle in the x direction;
φ_{y} is the titling angle in the y direction;
Δhₓ is the height difference at the two end-positions in the x direction;
Δh_{y} is the height difference at the two end-positions in the y direction;
Δx is the distance between the two end rows of balls 11 in the x direction; and
Δy is the distance between the two end rows of balls 11 in the y direction;

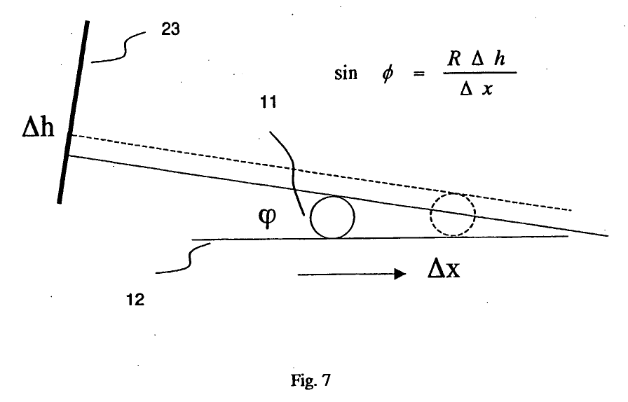

FIG. 7 illustrates the algorithm used for automatic determination of the inspection angle 30 for each die/substrate under measurement. An image of any selected row of balls 11 is captured at a place within the depth of focus of the telecentric lens. Then the row of balls is moved to a second place which is still within the depth of focus of the telecentric lens and the height image is captured. The inspection angle is then determined as follows:

$$α = arc sin ( \frac{{R}_{3 d} Δ h}{Δ x} )$$

where
α is the inspection angle;
R_{3d} is the calibrated resolution of the tilted camera;
Δx is the distance moved; and
Δh is the resulting height variation.

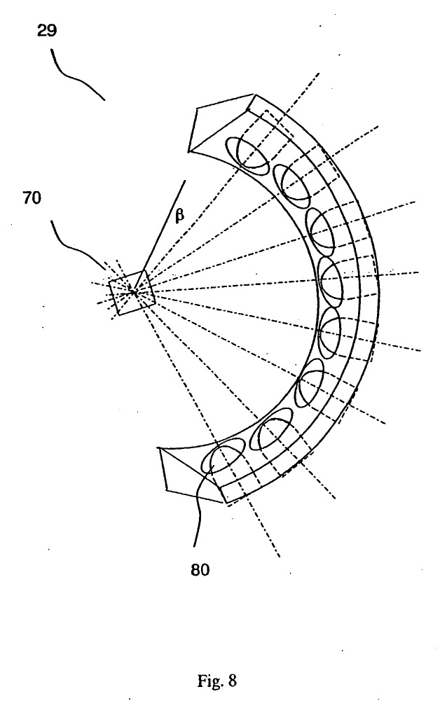

FIG. 8 illustrates a preferred embodiment of the back lighting source 29. A number of LEDs 80 form an arc light, each LED 80 directed to an object 11 under inspection at the same angle. This illumination design maximizes the efficiency of the light energy.

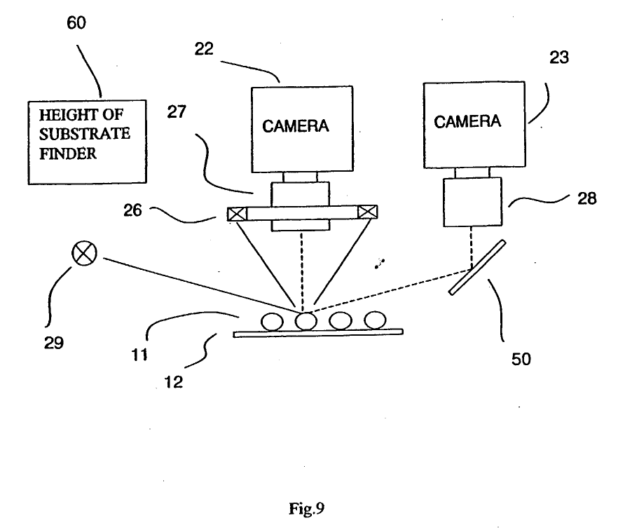

Referring to FIG. 9, this embodiment uses a mirror 50 to reflect the image of the balls 11 into camera 23 for measuring height A second camera 22 is used to calculate the position of each ball 11 as X-Y co-ordinates on the substrate 12.

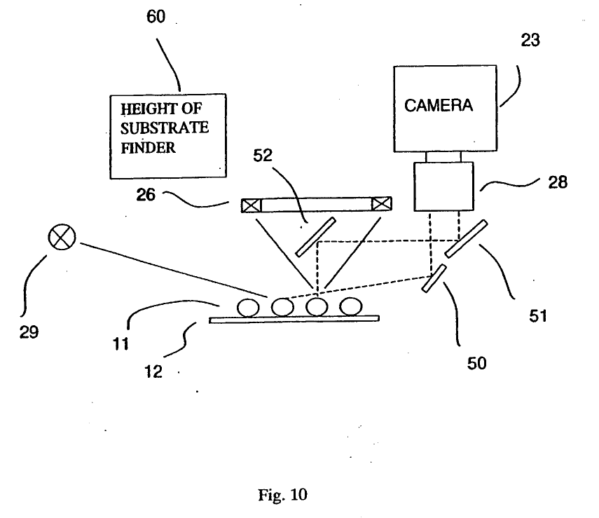

Referring to FIG. 10, this embodiment uses three mirrors 50, 51, 52 to reflect the image of the balls 11 into a camera 23. The fields of view for the two parts of the image on CCD array 23 may be different.

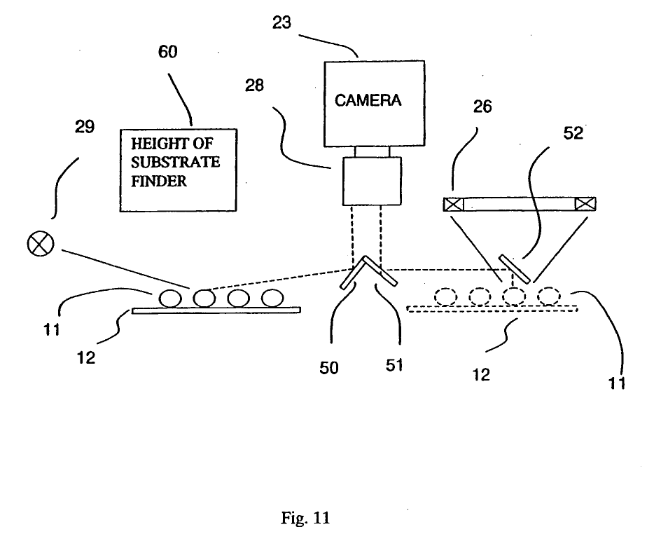

Referring to FIG. 11, in a different arrangement to the embodiment depicted in FIG. 6, this embodiment uses three mirrors 50, 51, 52 to reflect the imaging light of the balls 11 to a camera 23.

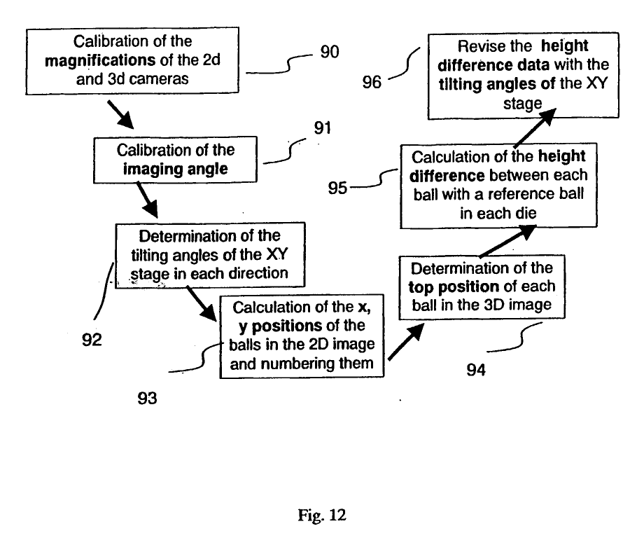

Referring to FIG. 12, the inspection process for three-dimensional inspection of solder balls 11 on a BGA 12 involves calibrating 90 the magnification (M) of the cameras 22, 23. Next, the imaging angle 30 for the camera 23 which captures the oblique image is calibrated 91 by using a single ball 11 as a reference. After calibration 90, 91, the tilting angle of the substrate 12 is determined 92 in each direction. The position of the balls 11 are calculated 93 as X-Y co-ordinates based on the image captured by the camera 22 of the top of the balls 11. The top position or height of the balls is determined 94 using the oblique image captured by the other camera 23. The height difference is calculated 95 between each ball 11 and the reference ball 11. This is performed by an additional device, for example, Height of Substrate Finder 60, which measures the absolute height of the reference ball on the substrate 12. The height differences and the tilting angle are revised 96 in to identify it any balls 11 on the substrate 12 are defective. Balls 11 which do not meet a certain height criteria are classified as defective and their position on the substrate 12 is identified in X-Y co-ordinates.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. An inspection system for three dimensional inspection of minute objects on a substrate, the system comprising:
a calibration module to calibrate an inspection angle for capturing an oblique image of the objects, the calibration of the inspection angle being performed by using one object as a reference;
at least one image capturer to capture a first image of the objects, and to capture an oblique image of the objects; and
an image processor to determine the position of the objects using the first image, and the height of the objects using the oblique image and the first image;
wherein if the height of an object is not within a predetermined criteria it is classified as defective and the position of the defective object is identified.

2. The system according to claim 1, further comprising a tilt measurement module to measure a tilting angle of the substrate.

3. The system according to claim 2, wherein the tilting angle is used when determining the position and height of the objects.

4. The system according to claim 1, wherein the inspection angle is calibrated according to the number of objects to be inspected per image capture.

5. The system according to claim 1, wherein the inspection angle is approximately 10°.

6. The system according to claim 1, wherein the inspection angle is greater than 10° to enable high measurement speed.

7. The system according to claim 1, further comprising an illumination source to illuminate the objects on the substrate.

8. The system according to claim 7, wherein the illumination source for imaging of object height is an arc or line arrangement of Light Emitting Diodes (LEDs) or fiber bundle.

9. The system according to claim 7, wherein the illumination source strobes the objects when capturing each image.

10. The system according to claim 1, further comprising at least one light re-director to direct light from various viewing angles into the at least one image capturer.

11. The system according to claim 10, wherein the reflective surface is a mirror.

12. The system according to claim 1, wherein the at least one image capturer has a telecentric lens.

13. The system according to claim 1, wherein the optical axis of a first of the at least one image capturer is substantially perpendicular to the plane of the substrate.

14. The system according to claim 1, wherein the optical axis of a second image of the at least one image capturer is at angle α to the plane of the substrate.

15. The system according to claim 1, wherein the substrate is a semiconductor chip, printed circuit board, semiconductor wafer, integrated circuit module or electronic device.

16. The system according to claim 1, wherein the objects are solder balls.

17. The system according to claim 16, wherein the solder balls are arranged as a ball grid array (BGA).

18. The system according to claim 1, wherein the at least one image capturer is a Charge Coupled Device (CCD) digital camera or CMOS digital camera.

19. A method for three dimensional inspection of minute objects on a substrate, the method comprising:
calibrating an inspection angle for capturing an oblique image of the objects, the calibration of the inspection angle being performed by using one object as a reference;
capturing a first image and the oblique image of the objects; and
determining the position of the objects using the first image, and the height of the objects using the oblique image and the first image;
wherein if the height of an object is not within a predetermined criteria it is classified as defective and the position of the defective object is identified.

20. The method according to claim 19, further comprising an initial step of calibrating the magnification of an image capturer to capture the images of the objects.

21. The method according to claim 19, further comprising the step of determining whether the substrate is tilted at a tilting angle.

22. The method according to claim 21, wherein the height of the objects is revised with the tilting angle.

23. The method according to claim 22, wherein the height of the objects is calculated by comparing the objects to the height of the object used as the reference.

24. The method according to claim 22, wherein an absolute height of each object is determined by a trigonometric algorithm or by auto-focus, by confocal or by interferometry method.

25. The method according to claim 22, wherein an absolute height of each object may be determined by combining its normal value and measured height variation if the average ball height is substantially close to the designed normal value.

26. The method according to claim 19, wherein the shape of the head of the objects is determined using the oblique image.

27. The method according to claim 19, wherein all the objects on the substrate is captured in each image.

28. An inspection system for three dimensional inspection of minute objects on a substrate, the system comprising:
a tilt measurement module to measure a tilting angle of the substrate,
at least one image capturer to capture a first image of the objects, and to capture an oblique image of the objects; and
an image processor to determine the position of the objects using the first image, the height of the objects using the oblique image and the first image, and compensation for the tilting angle;
wherein if the height of an object is not within a predetermined criteria it is classified as defective and the position of the defective object is identified.

29. The system according to claim 28, further comprising a calibration module to calibrate an inspection angle for capturing an oblique image of the objects, the calibration of the inspection angle being performed by using one object as a reference.

30. A method for three dimensional inspection of minute objects on a substrate, the method comprising:
measuring a tilting angle of the substrate;
capturing a first image and an oblique image of the objects; and
determining the position of the objects using the first image, the height of the objects using the oblique image and the first image, and compensation for the tilting angle;
wherein if the height of an object is not within a predetermined criteria it is classified as defective and the position of the defective object is identified.
